(19) United States
(12) Patent Application Publication
(10) Pub. No.: US 2023/0113751 A1
(43) Pub. Date: Apr. 13, 2023

(54) ANTENNA, ANTENNA ASSEMBLY, AND WIRELESS COMMUNICATION DEVICE

(71) Applicant: SZ DJI TECHNOLOGY CO., LTD., Shenzhen (CN)

(72) Inventors: Mu FANG, Shenzhen (CN); Chao LYU, Shenzhen (CN); Chao MA, Shenzhen (CN)

(73) Assignee: SZ DJI TECHNOLOGY CO., LTD., Shenzhen (CN)

(21) Appl. No.: 17/970,500

(22) Filed: Oct. 20, 2022

Related U.S. Application Data
(63) Continuation of application No. PCT/CN2020/087318, filed on Apr. 27, 2020.

(51) Int. Cl. H01Q 1/50; H01Q 1/24; H01Q 1/36; H01Q 5/47; H01Q 15/14

(52) U.S. Cl. CPC H01Q 1/50; H01Q 1/24; H01Q 1/36; H01Q 5/47; H01Q 15/14

(57) ABSTRACT

An antenna, an antenna assembly and a wireless communication device are provided. The antenna includes an antenna substrate; and at least one radiation unit disposed on the antenna substrate, each of the at least one radiation unit including: a first radiation branch, and a second radiation branch, where one of the first radiation branch or the second radiation branch is connected to a feeding point, the other of the first radiation branch or the second radiation branch is connected to a ground point, an end part of the first radiation branch bends toward the second radiation branch, and an end part of the second radiation branch is extend in a direction away from the first radiation branch.

### RELATED APPLICATIONS

This application is a continuation application of PCT application No. PCT/CN2020/087318, filed on Apr. 27, 2020, and the content of which is incorporated herein by reference in its entirety.

### TECHNICAL FIELD

The present disclosure relates to the technical field of wireless communication, and specifically, to an antenna, an antenna assembly, and a wireless communication device.

### BACKGROUND

Wireless communication devices such as remote controls usually use antennas to transmit and receive electromagnetic wave signals. In relevant technologies, an antenna may include one or more symmetrical sets of radiation branches. However, the beam direction of the antenna with symmetrical radiation branches may not be easily adjustable to the desired direction, thus the radiation performance of the antenna may be limited.

### BRIEF SUMMARY

The present disclosure provides an antenna, an antenna assembly, and a wireless communication device.

In some exemplary embodiments of the present disclosure, a remote controller for controlling an unmanned aerial vehicle (UAV) is provided, including a body; and a drawer structure, movably connected to the body, and including an antenna; when the drawer structure moves relative to the body, the antenna moves close to or away from the body with the drawer structure.

In some exemplary embodiments of the present disclosure, an antenna is provided, including: an antenna substrate; and at least one radiation unit disposed on the antenna substrate, each of the at least one radiation unit including: a first radiation branch, and a second radiation branch, where one of the first radiation branch or the second radiation branch is connected to a feeding point, the other of the first radiation branch or the second radiation branch is connected to a ground point, an end part of the first radiation branch bends toward the second radiation branch, and an end part of the second radiation branch is extend in a direction away from the first radiation branch.

In some exemplary embodiments of the present disclosure, an antenna assembly is provided, including: at least one antenna, each including: an antenna substrate; at least one radiation unit disposed on a first surface of the antenna substrate, each of the at least one radiation unit including: a first radiation branch, and a second radiation branch, where one of the first radiation branch or the second radiation branch is connected to a feeding point, the other of the first radiation branch or the second radiation branch is connected to a ground point, and an end part of the first radiation branch bends toward the second radiation branch, and an end part of the second radiation branch is extend in a direction away from the first radiation branch; and at least one reflector disposed on a second surface of the antenna substrate opposite to the first surface, each of the at least one reflector including a reflective substrate and a reflective branch disposed on the reflective substrate, the reflective branch reflecting electromagnetic waves radiated by the at least one radiation unit.

In some exemplary embodiments of the present disclosure, a wireless communication device is provided, including: a body; at least one antenna mounted on the body, each of the at least one antenna including: an antenna substrate; and at least one radiation unit disposed on the antenna substrate, each of the at least one radiation unit including: a first radiation branch, and a second radiation branch, where one of the first radiation branch or the second radiation branch is connected to a feeding point, the other of the first radiation branch or the second radiation branch is connected to a ground point, and an end part of the first radiation branch bends toward the second radiation branch, and an end part of the second radiation branch is extend in a direction away from the first radiation branch.

The wireless communication device in some exemplary embodiments of the present disclosure may adjust the beam direction of the antenna to a desired direction, or may achieve forward directional radiation, and reduce the reflection deterioration effect of the back metal object on antenna performance.

The additional aspects and advantages of the exemplary embodiments of the present disclosure will be illustrated or become apparent in the following description, or may be understood through the practice of the present disclosure.

### BRIEF DESCRIPTION OF THE DRAWINGS

The foregoing and/or additional aspects and advantages of the present disclosure will become apparent and readily understandable from the description of the exemplary embodiments with reference to the following accompanying drawings, in which:

FIG. 1 is a schematic structural diagram of an antenna according to some exemplary embodiments of the present disclosure;

FIG. 2 is a schematic structural diagram of an antenna according to some exemplary embodiments of the present disclosure;

FIG. 3 is a schematic structural diagram of an antenna according to some exemplary embodiments of the present disclosure;

FIG. 4 is an exploded schematic diagram of an antenna according to some exemplary embodiments of the present disclosure;

FIG. 5 is a schematic structural diagram of a feeding connector according to some exemplary embodiments of the present disclosure;

FIG. 6 is a schematic structural diagram of an antenna according to some exemplary embodiments of the present disclosure;

FIG. 7 is a schematic structural diagram of an antenna assembly according to some exemplary embodiments of the present disclosure;

FIG. 8 is a schematic structural diagram of an antenna assembly according to some exemplary embodiments of the present disclosure;

FIG. 9 is a schematic structural diagram of an antenna assembly according to some exemplary embodiments of the present disclosure;

FIG. 10 shows a radiation pattern of a low frequency direction and a high frequency direction on a horizontal plane of an antenna assembly according to some exemplary embodiments of the present disclosure;

FIG. 11 shows a radiation pattern of a low frequency direction and a high frequency direction on a pitch plane of an antenna assembly according to some exemplary embodiments of the present disclosure;

FIG. 12 is a reflection coefficient graph of an antenna assembly according to some exemplary embodiments of the present disclosure;

FIG. 13 is a schematic structural diagram of a wireless communication device according to some exemplary embodiments of the present disclosure;

FIG. 14 is a schematic structural diagram of a wireless communication device according to some exemplary embodiments of the present disclosure;

FIG. 15 is a partial schematic structural diagram of a wireless communication device according to some exemplary embodiments of the present disclosure; and

FIG. 16 is a partial schematic structural diagram of a wireless communication device according to some exemplary embodiments of the present disclosure.

### DETAILED DESCRIPTION

The exemplary embodiments of the present disclosure are described below in detail; the exemplary embodiments are shown in the accompanying drawings, in which the same or similar numerals represent the same or similar elements or elements having the same or similar functions. The embodiments described below with reference to the accompanying drawings are exemplary, and are only intended to explain the present disclosure, which should not be construed as limitations of the present disclosure.

In the description of the present disclosure, it needs to be understood that directions or position relationships indicated by terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise” and “counterclockwise” are directions or position relationships based on the accompanying drawings, and are used only for the ease of describing the present disclosure and simplifying the descriptions. The terms do not indicate or imply that a mentioned apparatus or unit must have a specific direction and must be constructed and operated in a specific direction, and therefore cannot be understood as limitations on the present disclosure. In addition, the term “first” and “second” are used only for the purposes of description, and should not be understood as indicating or implying relative importance or implicitly indicating the number of technical features denoted. Thus, features defined with “first” and “second” may explicitly or implicitly include one or more of the features. In the description of the present disclosure, unless otherwise explicitly specified and defined, the term “plurality” indicates two or more.

In the description of the present disclosure, it should be noted that, unless otherwise explicitly specified and defined, the term “installing”, “joining” and “connecting” should be understood in a broad senses, for example, a fixed connection, a detachable connection, or an integrated connection; a mechanical connection or an electrical connection; a direct connection, or an indirect connection through an intermediate medium, an internal connection between two elements or an interaction between two elements. A person of ordinary skill in the art may understand specific meanings of these terms in the present disclosure based on specific situations.

In the present disclosure, unless otherwise expressly specified and defined, that a first feature is “above” or “under” a second feature may include that the first feature is in direct contact with the second feature, or that the first feature and the second feature are not in direct contact with each other but are in contact by using another feature between them. In addition, that the first feature is “over”, “above”, and/or “on” the second feature may include that the first feature is directly above and diagonally above the second feature, or may indicate that an attitude of the first feature is higher than that of the second feature. The first feature is “beneath”, “below”, and/or “under” the second feature may include that the first feature is directly below and/or diagonally below the second feature, or may indicate that the altitude of the first feature is lower than that of the second feature.

The terminology used herein is for the purpose of describing particular exemplary embodiments only and is not intended to be limiting. As used herein, the singular forms “a”, “an” and “the” may include their plural forms as well, unless the context clearly indicates otherwise. When used in this disclosure, the terms “comprises”, “comprising”, “includes” and/or “including” refer to the presence of stated features, integers, steps, operations, elements, and/or components, but do not preclude the presence or addition of one or more other features, integers, steps, operations, elements, components, and/or groups thereof.

The present disclosure provides some exemplary embodiments for implementing different structures of the present disclosure. To simplify the present disclosure, components and dispositions of some examples are described herein. Evidently, the descriptions are only exemplary and are not intended to limit the present disclosure. In addition, reference numerals and/or reference letters may be repeated in different examples in the present disclosure, and such repetition is for purposes of simplification and clarity and is not indicative of relationships between the implementations and/or dispositions discussed. In addition, the present disclosure provides examples of various specific processes and materials, but those of ordinary skill in the art may realize the applications of other processes and/or use of other materials.

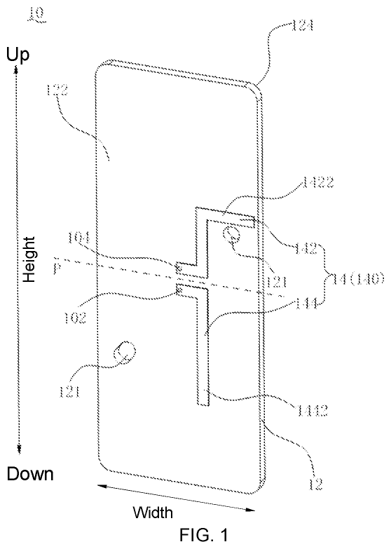

Referring to FIG. 1, an antenna 10 in some exemplary embodiments of the present disclosure may include an antenna substrate 12 and a radiation unit 14 disposed on the surface of the antenna substrate 12. The radiation unit 14 may include a first radiation branch 142 and a second radiation branch 144. The first radiation branch 142 may be connected to a feeding point 102 and the second radiation branch 144 may be connected to a ground point 104, or the first radiation branch 142 may be connected to the ground point and the second radiation branch 144 may be connected to the feeding point 102. An end part 1422 of the first radiation branch 142 may bend toward the direction of the second radiation branch 144, an end part 1442 of the second radiation branch 144 may extend in the direction away from the first radiation branch 142.

In the antenna 10 according to some exemplary embodiments of the present disclosure, the end part 1422 of the first radiation branch 142 may bend toward the direction of the second radiation branch 144, the end part 1442 of the second radiation branch 144 may extend in the direction away from the first radiation branch 142, that is, the first radiation branch 142 and the second radiation branch 144 may be set asymmetrically, therefore, the current path distribution and the equivalent phase center of the antenna 10 may be adjusted, so that the beam direction of the antenna 10 may be shifted to the direction where the second radiation branch 144 is located, and the beam direction of the antenna 10 may be adjusted to the desired direction.

It may be understood that the antenna 10 according to some exemplary embodiments of the present disclosure may be used in wireless communication devices, such as a remote control of an unmanned aerial vehicle. In existing technologies, for the antenna design of the remote control of the unmanned aerial vehicle, the maximum radiation direction of the antenna is normally located in the plane of the remote control. However, some users may hold the remote control such that the remote control would point upward, that is, the remote control often has a upward tilt angle, and the maximum radiation direction of the antenna is tilted upward, resulting in attenuation of the horizontal gain. The greater the remote control tilt angle, the greater the horizontal direction gain attenuation.

Therefore, in contrast to the antenna in the existing technologies where the first radiation branch and the second radiation branch set symmetrically, in the antenna 10 according to some exemplary embodiments of the present disclosure, the first radiation branch 142 and the second radiation branch 144 may be set asymmetrically. The end part 1422 of the first radiation branch 142 may bend toward the direction of the second radiation branch 144, so that the overall height of the current path distribution of the antenna 10 may be shifted to the direction of the second radiation branch 144. Thus, the equivalent phase center of the entire radiation unit 14 may also be shifted toward the second radiation branch 144. In this way, the beam direction of the antenna 10 may be adjusted to a desired direction, so that the wireless communication device equipped with the above-mentioned antenna 10 may satisfy the signal coverage of the desired direction.

In some exemplary embodiments shown in FIG. 1, the first radiation branch 142 and the second radiation branch 144 may be respectively located on both sides of the axis of symmetry P of the antenna substrate 12, the first radiation branch 142 may be located above the second radiation branch 144, and the end part 1422 of the first radiation branch 142 may be partially bent downward, the first radiation branch 142 may be bent into an L-shape as a whole. Therefore, the overall height of the current path distribution of the antenna 10 may decrease, and the equivalent phase center of the entire radiation unit 14 may be downwardly offset to a certain extent, i.e., the equivalent phase center may be offset towards the second radiation branch 144 with respect to the axis of symmetry P.

It should be noted that, between the first radiation branch 142 and the second radiation branch 144, one may be connected to the feeding point 102, and the other one may be connected to the ground point 104. In some exemplary embodiments, the first radiation branch 142 may be connected to the feeding point 102, the second radiation branch 144 may be connected to the ground point 104; or the first radiation branch 142 may be connected to the ground point 104, the second radiation branch 144 may be connected to the feeding point 102, details of the connecting patterns are not limited herein.

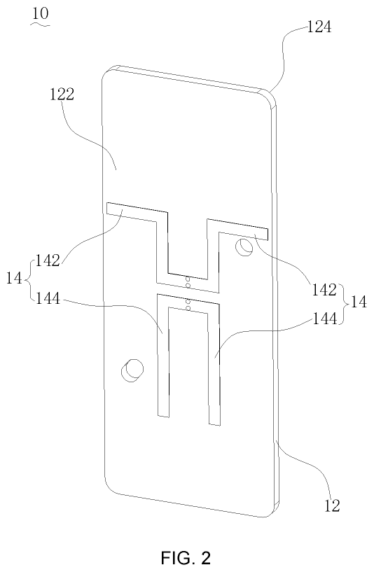

Referring to FIG. 2 to FIG. 5, in some exemplary embodiments, the antenna substrate 12 may include a first surface 122 and a second surface 144 opposite to each other. The radiation unit 14 may be disposed on the first surface 122, and the second surface 124 may include a feeding connector 16. The feeding connector 16 may include a feeding branch 162 and a ground branch 164, the feeding branch 162 may be electrically connected to the feeding point 102, the ground branch 164 may be electrically connected to the ground point 104.

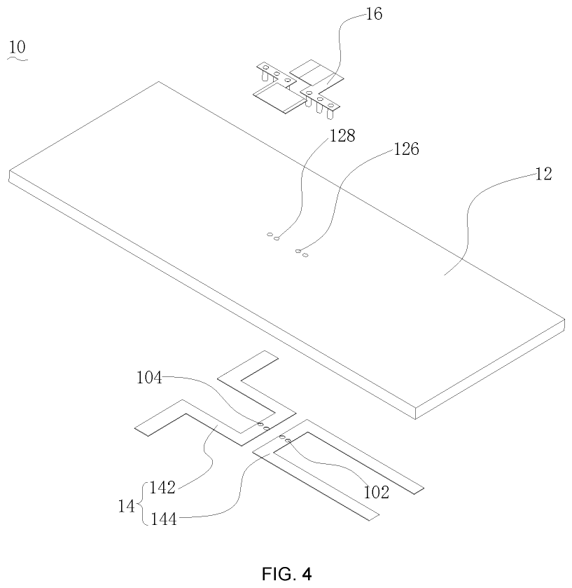

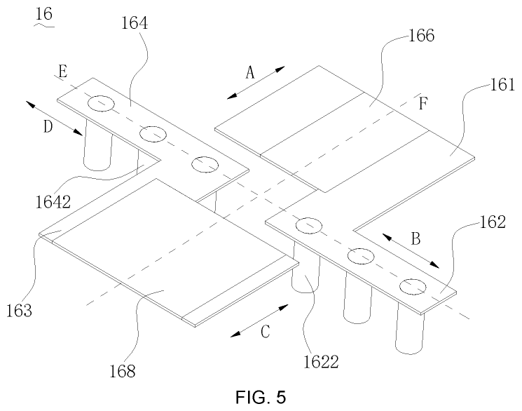

Specifically, referring to FIG. 4 and FIG. 5, the antenna substrate 12 may include a first metal through hole 126 and a second metal through hole 128. The feeding branch 162 may be connected to the feeding point 102 via the first metal through hole 126 formed through the antenna substrate 12, the ground branch 164 may be connected to the ground point 104 via the second metal through hole 128 formed through the antenna substrate 12. In some exemplary embodiments, the feeding branch 162 may be connected to a first metal connecting post 1622, and the ground branch 164 may be connected to a second metal connecting post 1642. The first metal connecting post 1622 of the feeding branch 162 may be connected to the first radiation branch 142 or the second radiation branch 144 through the first metal through hole 126, and the connecting point thereof may form the feeding point 102. The second metal connecting post 1642 of the ground branch 164 may be connected to the second radiation branch 144 or the first radiation branch 142 through the second metal through hole 128, and the connecting point thereof may form the ground point 104.

Therefore, the first radiation branch 142 or the second radiation branch 144 may connect to the feeding branch 162 via the feeding point 102, the second radiation branch 144 or the first radiation branch 142 may connect to the ground branch 164 via the ground point 104, so that feeding may be realized through a transmission line (for example, a coaxial feed line 18) connected to the feeding connector 16 to conduct electricity.

In some exemplary embodiments shown in the figures, the first metal through hole 126 and the second metal through hole 128 may be perpendicular to the antenna substrate 12, so that the radiation unit 14 and the feeding connector 16 may be disposed on the opposite surfaces of the antenna substrate 12, so as to save material and simplify the manufacturing process. Certainly, in some exemplary embodiments, the first metal through hole 126 and the second metal through hole 128 may be slanted with respect to the antenna substrate 12.

It should be noted that, in some exemplary embodiments shown in FIG. 2 to FIG. 5, the quantity of the radiation units 14 may be two. The quantity of the first metal through holes 126, the second metal through holes 128, the first metal connecting posts 1622, the second metal connecting posts 1642 may be the same as, or more than, the quantity of the radiation units 14.

Referring to FIG. 5, in some exemplary embodiments, the feeding connector 16 may further include a first connecting branch 166 connected to the feeding branch 162 and a second connecting branch 168 connected to the ground branch 164. The first connecting branch 166 and the feeding branch 162 may be connected via a first transverse connector 161, the extension direction A of the first connecting branch 166 may be perpendicular to the extension direction B of the feeding branch 162. The second connecting branch 168 and the ground branch 164 may be connected via a second transverse connector 163, the extension direction C of the second connecting branch 168 may be perpendicular to the extension direction D of the ground branch 164.

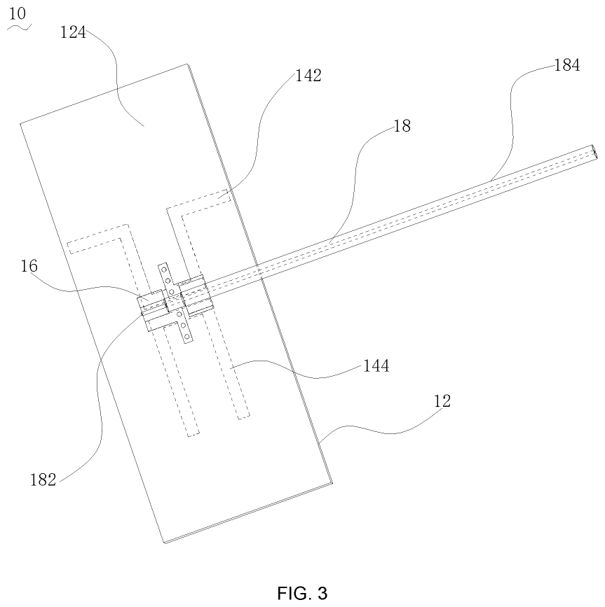

Specifically, referring to FIG. 3, the antenna 10 may include a coaxial feed line 18, an inner core 182 of the coaxial feed line 18 may be connected to the first connecting branch 166, a shielding layer 184 of the coaxial feed line 18 may be connected to the second connecting branch 168, the direction of the coaxial feed line 18 may be perpendicular to the direction of polarization of the antenna 10. Therefore, the first connecting branch 166 and the second connecting branch 168 may be used to connect to the coaxial feed line 18 to conduct electricity. The direction of the coaxial feed line 18 may be perpendicular to the direction of polarization of the antenna 10, which may maximumly eliminate the mutual interference between the coaxial feed line 18 and the radiation unit 14, and avoid affecting the performance of the antenna 10. Thus, the radiation pattern of the antenna 10 including the coaxial feed line 18 may be closer to the radiation pattern without the influence of the coaxial feed line.

It may be understood that, the first connecting branch 166 and the feeding branch 162 may be connected via the first transverse connector 161, the extension direction A of the first connecting branch 166 may be perpendicular to the extension direction B of the feeding branch 162, thereby forming a Z-shaped structure (referring to FIG. 5). The second connecting branch 168 and the ground branch 164 may be connected via the second transverse connector 163; the extension direction C of the second connecting branch 168 may be perpendicular to the extension direction D of the ground branch 164, also forming a Z-shaped structure. The two Z-shaped structures may be rotationally symmetrical with respect to the center, so that the connecting line E between the feeding branch 162 and the ground branch 164 and the connecting line F between the first connecting branch 166 and the second connecting branch 168 are perpendicular to each other, so that the direction of the coaxial feed line 18 may be perpendicular to the direction of polarization of the antenna 10.

Further, the size of the first connecting branch 166 may be different from the size of the second connecting branch 168, so that it is convenient to distinguish between the first connecting branch 166 and the second connecting branch 168 when connecting the coaxial feed line 18. In some exemplary embodiments shown in the figures, the size of the first connecting branch 166 may be smaller than the size of the second connecting branch 168, the shapes of the first connecting branch 166 and the second connecting branch 168 may both be rectangles, and the size of the connecting branch may refer to the area of the rectangle. In some exemplary embodiments, the size of the first connecting branch 166 may be larger than the size of the second connecting branch 168, the shapes of the first connecting branch 166 and the second connecting branch 168 may be square, circular, oval, or other shapes, or the like.

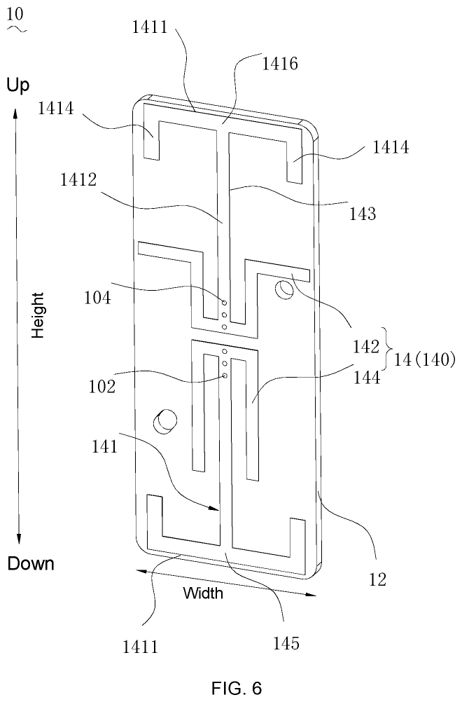

Referring to FIG. 6, in some exemplary embodiments, the radiation unit 14 may be a high-frequency radiation unit 140, the antenna 10 may further include a low-frequency radiation unit 141. The low-frequency radiation unit 141 may include a third radiation branch 143 and a fourth radiation branch 145. Between the third radiation branch 143 and the fourth radiation branch 145, one may be connected to the feeding point 102, and the other one may be connected to the ground point 104. The third radiation branch 143 and the fourth radiation branch 145 may be symmetrically arranged with respect to a symmetric axis of the antenna substrate. The third radiation branch 143 may include a first vertical branch 1412 and two second vertical branches 1414. The fourth radiation branch 145 may further include a first vertical branch 1412 and two second vertical branches 1414. The two second vertical branches 1414 may be respectively connected to two opposite sides of one end of the first vertical branch 1412 via a first transverse branch 1416, the length of the first vertical branch 1412 may be greater than the length of the second vertical branch 1414.

It may be understood that, the high-frequency radiation unit 140 and the low-frequency radiation unit 141 may form a dual-frequency antenna 10. The size of the dual-frequency antenna 10 may be determined mainly by the size of the radiation branch(es) of the low-frequency radiation unit 141. In the present disclosure, the sizes in the longitudinal direction (that is, the vertical direction shown in FIG. 6) of the low-frequency radiation unit 141 may be less than or equal to a quarter of the wavelength of the low-frequency electromagnetic waves generated by the low-frequency radiation unit 141. Specifically, the two second vertical branches 1414 may be located at the end 1411 of the low-frequency radiation unit 141, the first vertical branch 1412 may be located between the two second vertical branches 1414, the first vertical branch 1412 and the two second vertical branches may form a structure that resembles uppercase E. Therefore, the current path may be effectively increased with a smaller longitudinal (vertical) size, thereby realizing the resonance of the low-frequency antenna 10, at the same time, this miniaturization may reduce the length of the current integration path along the electric field direction in the structure of the antenna 10, and may also expand the beam width of the plane of antenna 10 E.

In some exemplary embodiments shown in the figures, the quantity of the high-frequency radiation units 140 may be two. The two high-frequency radiation units 140 may be symmetrically arranged on the antenna substrate along the length direction of the first vertical branch 1412, the two high-frequency radiation units 140 may be located between two ends 1411 of the low-frequency radiation unit 141. Therefore, the high-frequency radiation and reception performance of the antenna 10 may be enhanced. In some exemplary embodiments, the quantity of the high-frequency radiation unit 140 may be one; the high-frequency radiation unit 140 may be disposed on one end of the first vertical branch 1412 and may be located between two ends 1411 of the low-frequency radiation unit 141.

It should be noted that, between the third radiation branch 143 and the fourth radiation branch 145, one may be connected to the feeding point 102, and the other one may be connected to the ground point 104. In some exemplary embodiments, the third radiation branch 143 may be connected to the feeding point 102, the fourth radiation branch 145 may be connected to the ground point 104. In some exemplary embodiments, the third radiation branch 143 may be connected to the ground point 104, the fourth radiation branch 145 may be connected to the feeding point 102, and details are not limited herein.

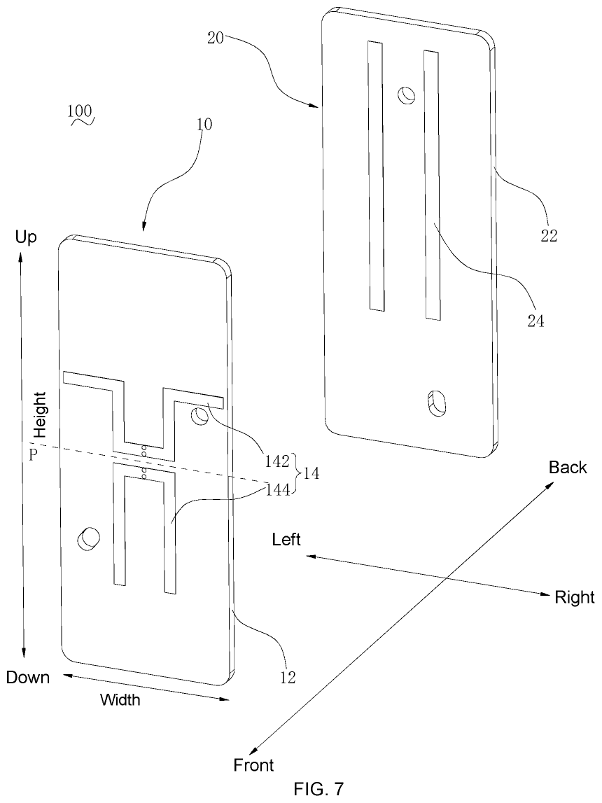

Referring to FIG. 7, an antenna assembly 100 according to some exemplary embodiments of the present disclosure may include the antenna 10 and a reflector 20 disposed on the side opposite to the radiation unit 14. The reflector 20 may include a reflective substrate 22 and a reflective branch 24 disposed on the surface of the reflective substrate 22. The reflective branch 24 may be used to reflect electromagnetic waves radiated by the radiation unit 14.

The antenna assembly 100 according to some exemplary embodiments of the present disclosure may realize directional radiation of the antenna 10 by using the reflector 20 to reflect the electromagnetic waves radiated by the radiation unit 14 of the antenna 10, and may also reduce the reflection deterioration effect of the metal object behind the antenna 10 on the performance of the antenna 10.

It may be understood that the reflector 20 may be located directly behind the antenna 10, and forward directional radiation of the antenna 10 may be achieved by reflecting the backward radiation of the antenna 10. Forward and backward are opposite directions and are used for illustration purposes only. In some exemplary embodiments in FIG. 7, the quantity of the radiation units 14 may be two, the quantity of the reflective branches 24 may also be two.

It should be noted that, in some exemplary embodiments shown in the figures, the antenna substrate 12 and the reflective substrate 22 may both be printed circuit boards (PCB boards). In some exemplary embodiments, the antenna substrate 12 and the reflective substrate 22 may be other types of dielectric substrates. In some exemplary embodiments, the quantity of the reflective branches 24 may be two, each of the reflective branches may be linear.

It may be understood that comparing to a reflector with only one reflective branch 24, the reflector 20 with double reflective branches 24 may achieve stronger directional radiation effect and higher frequency band gain.

In some exemplary embodiments, the geometric center of the reflective branch 24 may be located on a side of the geometric center of the reflective substrate 22 where the first radiation branch 142 is located.

Therefore, the equivalent phase center of the reflective branch 24 may be skewed to the side where the first radiation branch 142 is located. In some exemplary embodiments shown in FIG. 7, the first radiation branch 142 and the second radiation branch 144 may be respectively located on both sides of the axis of symmetry P of the antenna substrate 12, the first radiation branch 142 may be located above the second radiation branch 144, and the equivalent phase center of the radiation unit 14 may be downwardly offset to a certain extent, i.e., the equivalent phase center of the radiation unit 14 may be offset towards the downward direction as shown in FIG. 7, which is towards the second radiation branch 144 with respect to the axis of symmetry P. The geometric center of the reflective branch 24 may be located on a side of the geometric center of the reflective substrate 22 where the first radiation branch 142 is located, and the reflective branch 24 may shift upward compared to the geometric center of the reflective substrate 22, so that the equivalent phase center of the reflective branch 24 may be upwardly offset to some extent, i.e., the equivalent phase center of the reflective branch 24 may be offset towards an opposite side of the axis of symmetry P comparing to the downwardly offset of the equivalent phase center of the radiation unit 14.

It may be understood that the antenna 10 and the reflector 20 may together form a binary antenna array, the direction of the phase center of the reflector 20 pointing to the phase center of the antenna 10 may be the array axis direction (the direction of the axis of the antenna array) of the binary antenna array, which may also determine the beam direction of the antenna 10. The downwardly offset of the phase center of the radiation unit 14 and the upwardly offset (i.e., offset towards the upper direction shown in FIG. 7 with respect to the axis P) of the phase center of the reflection branch 24 may cause the connecting line between the phase center of the reflector 20 and the phase center of the antenna 10 to form the largest possible pitch angle, which may also form a pitch angle in the direction of the array axis of the equivalent binary antenna array, so that a significant downward tilt of the beam direction may be achieved.

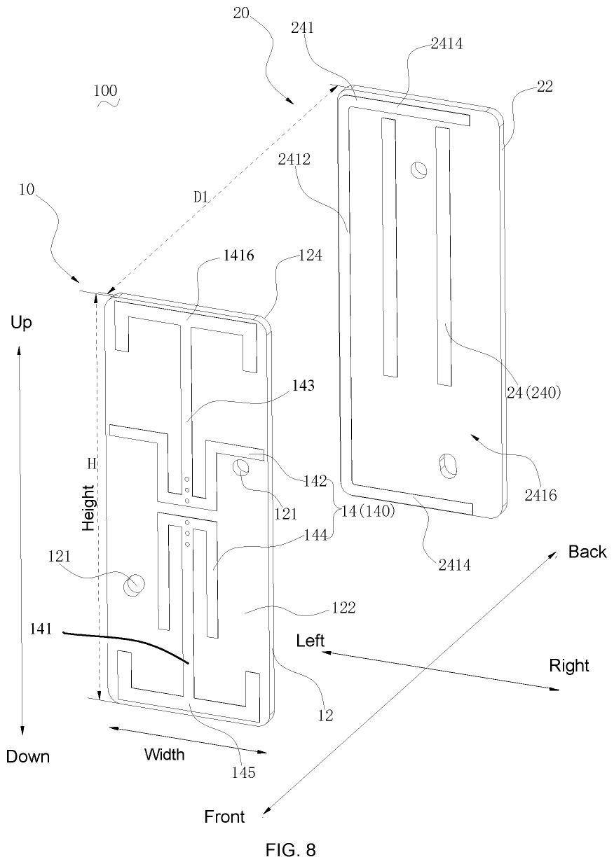

Referring to FIG. 8, in some exemplary embodiments, the radiation unit 14 may be a high-frequency radiation unit 140, the reflective branch 24 may be a high-frequency reflective branch 240. The high-frequency reflective branch 240 may be used to reflect high-frequency electromagnetic waves radiated by the high-frequency radiation unit 140. The antenna 10 may further include a low-frequency radiation unit 141, the reflective substrate 22 may further include a low-frequency reflective branch 241. The low-frequency reflective branch 241 may be used to reflect low-frequency electromagnetic waves radiated by the low-frequency radiation unit 141.

Specifically, the low-frequency reflective branch 241 may include at least one third vertical branch 2412 and at least two second transverse branches 2414, the at least two second transverse branches 2414 may be respectively connected to two ends of the third vertical branch 2412, and both may extend in the direction of the high-frequency reflective branch 240.

It may be understood that the at least one third vertical branch 2412 and the at least two second transverse branches 2414 may form C-shaped structure. Therefore, the low-frequency reflective branch 241 may obtain a longer current path in a smaller longitudinal (vertical) size by bending, so as to obtain a sufficient length to realize the reflection of low-frequency electromagnetic waves radiated by the low-frequency radiation unit 141.

In some exemplary embodiments, the spacing D1 between the reflector 20 and the antenna 10 may be less than one tenth of the wavelength of the low-frequency electromagnetic waves. In some exemplary embodiments, the spacing D1 between the reflector 20 and the antenna 10 may be less than one twelfth of the wavelength of the low-frequency electromagnetic waves. The antenna assembly 100 according to some exemplary embodiments of the present disclosure may radiate in the desired direction even when the spacing D1 between the reflector 20 and the antenna 10 is less than one tenth of the low-frequency electromagnetic waves. In existing technologies, the spacing between the conventional reflector and the antenna is required to be one-quarter wavelength, thus the spacing D1 in the antenna assembly 100 is greatly reduced comparing to spacing in the conventional antenna assembly, thereby achieving miniaturization of the antenna assembly 100. In some exemplary embodiments, the length H (i.e., height) of the antenna 10 and the length of the reflector 20 along the longitudinal direction of the antenna 10 and the reflector 20 may be less than or equal to a quarter of the wavelength of the low-frequency electromagnetic waves, thereby further reducing the size of the antenna assembly 100.

In some exemplary embodiments, the high-frequency reflective branch 240 may be located within a space enclosed by the two second transverse branches 2414 and the third vertical branch 2412.

It may be understood that the design of the low-frequency reflective branches 241 may leave space for the high-frequency reflective branches 240 on the reflective substrate 22, which may reduce the size of the reflector 20. The high-frequency reflective branch 240 and the low-frequency reflective branch 241 may work independently without interfering with each other.

In some exemplary embodiments, the low-frequency beam direction of the antenna assembly 100 may be shifted toward the opening 2416 of the low-frequency reflective branch 241.

It may be understood that, for the antenna 10, the third radiation branch 143 and the fourth radiation branch 145 of the low-frequency radiation unit 141 may be symmetrical along the height and may be symmetrical along the width of the antenna substrate 12 with respect to the geometric center of the antenna substrate 12, so their equivalent phase centers may be located in the geometric center of the antenna substrate 12. For the reflector 20, the low-frequency reflective branch 241 may be vertically symmetrical with respect to the center of the reflective substrate 22, but not symmetrical along the width of the antenna substrate 12, the main reflective area of the low-frequency reflective branch 241 may be located in the first vertical branch 1412, and its equivalent phase center may be located at the midpoint of the first vertical branch 1412. From the low-frequency reflective branch 241 of the reflector 20 to the antenna 10, the direction of the phase center connecting line may be biased toward the direction of the opening 2416 of the low-frequency reflective branch 241, so the low-frequency beam direction may also be biased toward the direction of the opening 2416 of the low-frequency reflective branch 241.

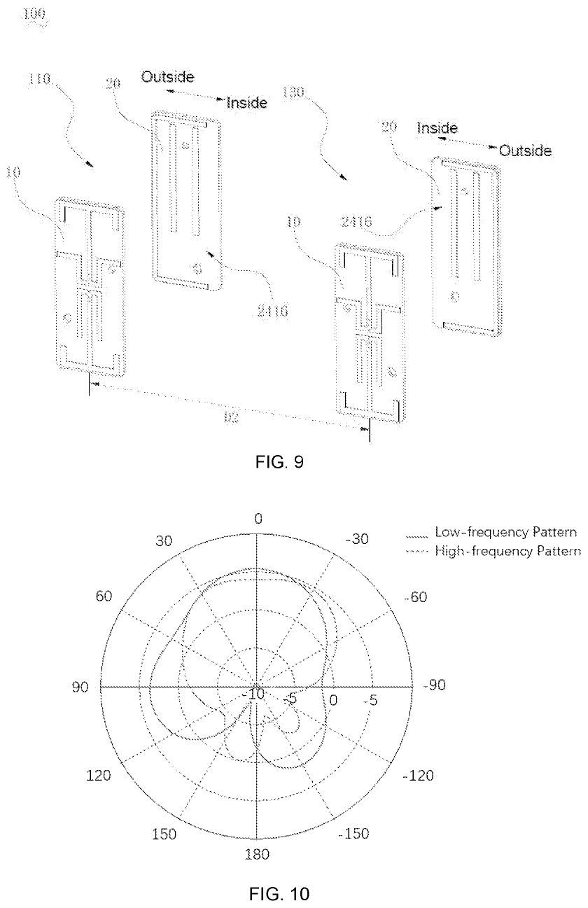

Referring to FIG. 9, in some exemplary embodiments, the antenna assembly 100 may include two antennas 10 and two reflectors 20. One antenna 10 and one corresponding reflector 20 may form a first antenna group 110, the other antenna 10 and the other corresponding reflector 20 may form a second antenna group 130. The first antenna group 110 and the second antenna group 130 may be spaced apart, and the opening 2416 of the first antenna group 110 may be set opposite to the opening 2416 of the second antenna group 130, that is, the opening 2416 of the first antenna group 110 may face the opening 2416 of the second antenna group 130.

It may be understood that two or more antenna groups placed in a co-polarized arrangement are often used in wireless communication devices such as remote controls, routers, and walkie-talkies. When the spacing between the antenna groups is large enough, the effect of mutual coupling between the antenna groups may be negligible. However, when the spacing between the antenna groups is reduced to slightly larger than the half wavelength of low-frequency electromagnetic waves, the mutual coupling between the antenna groups may be notably stronger, the antenna pattern will begin deviating from the original pattern, showing beam shift and other phenomena, and as the spacing further reduces, the effect of mutual coupling may further increase.

Specifically, in a dual antenna group placed in close proximity, if the spacing between the first antenna group 110 and the second antenna group 130 is less than half a wavelength, the dual antenna groups may experience strong mutual coupling effect therebetween, thereby causing the antenna 10 pattern to shift outside of the two antenna groups. In the present disclosure, by setting the openings 2416 of a pair of low-frequency reflective branches 241 to face each other, while the dual antenna group may radiate in the desired direction, oblique reflection inside the two antenna groups may be achieved to reversely offset and correct the beam shift caused by mutual coupling, so that the beam may point straight ahead. In the present disclosure, the dual antenna group may be arranged in a smaller space comparing to conventional dual antenna group and at the same time, the dual antenna group may achieve ideal performance. In some exemplary embodiments, the spacing D2 between the first antenna group 110 and the second antenna group 130 may be less than half of the wavelength of the low-frequency electromagnetic waves.

For example, a wireless communication device may be a remote control for controlling a movable platform. In existing technologies, for the antenna design of the remote control of the unmanned aerial vehicle, the maximum radiation direction of the antenna is normally located in the plane of the remote control body. However, some users may hold the remote control such that the remote control would point upward, that is, the remote control often has a certain upward tilt angle, and the maximum radiation direction of the antenna is tilted upward, resulting in attenuation of the horizontal gain. The greater the remote control tilt angle, the greater the horizontal direction gain attenuation.

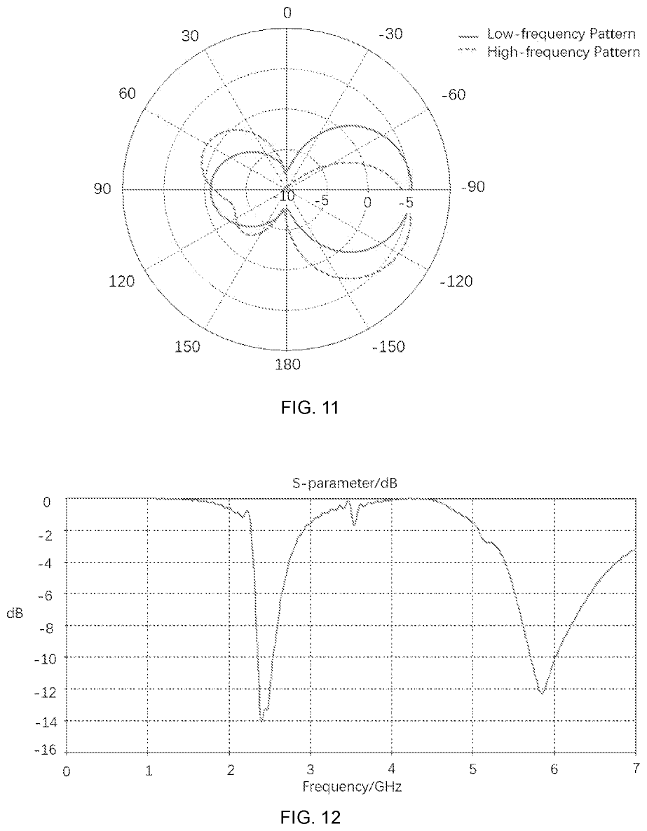

Referring to FIG. 10, FIG. 10 is a horizontal radiation pattern of an antenna assembly according to some exemplary embodiments of the present disclosure, where 0 degree correspond to a direction pointing directly forward. In the present disclosure, the compound design of the antenna 10 and the reflector 20 may achieve dual-frequency directional radiation and reduce a backward radiation of the antenna assembly, therefore reducing the reflection deterioration effect of the metal object behind the antenna on the performance of the antenna. FIG. 11 shows a dual-frequency radiation pattern of the antenna assembly 100 on a pitch plane, where −90 degrees correspond to a direction pointing directly forward and 0 degrees correspond to a direction pointing directly above, and it may be seen that the beam direction (maximum radiation direction) of the low-frequency pattern points directly forward in the horizontal plane direction, while the beam direction (maximum radiation direction) of the high-frequency pattern may be tilted down about 20˜30 degrees. For dual-frequency communication systems, this differentiated design of dual-frequency beam directions may allow radiation patterns to complement each other, that is, equivalent beam may be spread, which may allow better communication over a wider angle range and may expand the available communication angles. FIG. 12 shows a reflection coefficient graph of an antenna assembly reflecting the dual-frequency resonance of the antenna assembly 100.

In some exemplary embodiments, the antenna assembly 100 may include two antennas 10 and two reflectors 20, one antenna 10 and one corresponding reflector 20 may form a first antenna group 110, the other antenna 10 and the other corresponding reflector 20 may form a second antenna group 130, the first antenna group 110 and the second antenna group 130 may be spaced apart.

It may be understood that the high-frequency radiation and reception performance of the antenna 10 may be enhanced by using two antenna groups that are spaced apart. Specifically, the spacing between the first antenna group 110 and the second antenna group 130 may be less than half of the wavelength of the low-frequency electromagnetic waves.

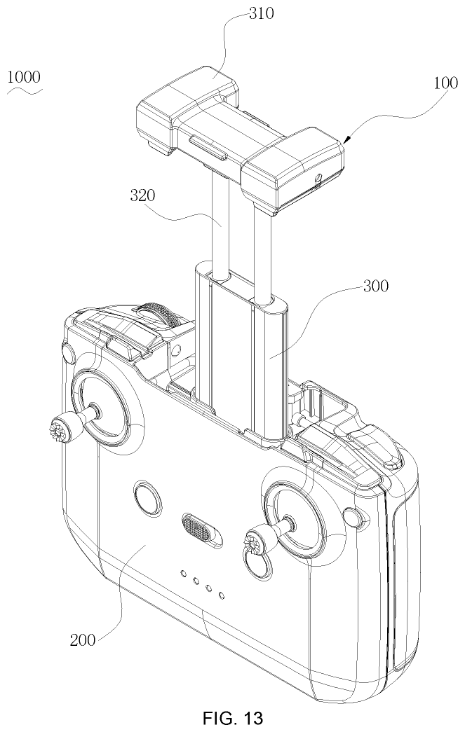

Referring to FIG. 13, the wireless communication device 1000 according to some exemplary embodiments of the present disclosure may include a body 200 and an antenna 10 the antenna 10 may be disposed in the body 200. In some exemplary embodiments, the wireless communication device 1000 may include an antenna assembly 100; the antenna assembly 100 may be disposed in the body 200.

The wireless communication device 1000 according to some exemplary embodiments of the present disclosure may adjust the beam direction of the antenna 10 to a desired direction, or may achieve forward directional radiation, and the reflection deterioration effect of the metal object behind the antenna 10 on the performance of the antenna 10 may be reduced.

It may be understood that the wireless communication device 100 may be a remote control, a router, or a walkie-talkie, or the like. For illustration purpose only, in some exemplary embodiments, the wireless communication device 1000 may be a remote control. The remote control may be used to control a movable platform. The movable platform may be an unmanned aerial vehicle, an unmanned car, a mobile robot, or the like.

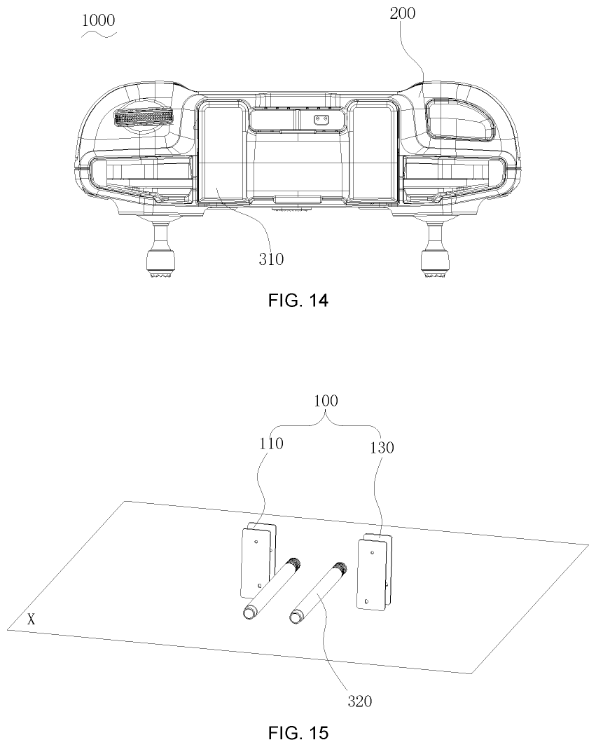

Referring to FIG. 13 and FIG. 14, in some exemplary embodiments, the wireless communication device 1000 may include a drawer structure 300. The drawer structure 300 may be movably connected to the body 200, the antenna 10 and/or the antenna assembly 100 may be disposed in the drawer structure. When the drawer structure moves relative to the body, the antenna 10 or the antenna assembly 100 may be able to follow the drawer structure to approach or move away from the body.

Specifically, the drawer structure 300 may be slidably connected to the body 200, so that the drawer structure 300 may be in a retracted state relative to the body 200 for easy carrying of the wireless communication device 1000, or an extended state for holding an external device 2000. In some exemplary embodiments, when the drawer structure 300 is in the extended state, the antenna 10 and/or the antenna assembly 100 may be capable of transmitting or receiving signals.

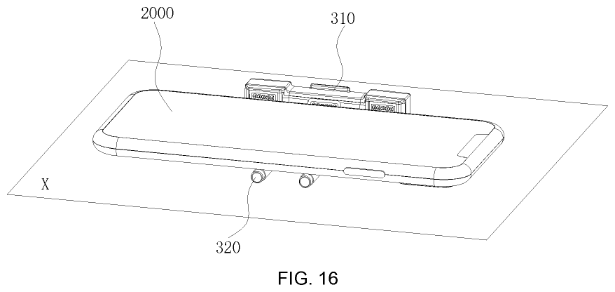

It may be understood that, referring to FIG. 16, when the antenna 10 and/or the antenna assembly 100 is pulled away from the body 200, the drawer structure 300 in the extended state may be used to hold the external device 2000 (such as a mobile phone, tablet, or the like) and the antenna 10 and/or the antenna assembly 100 may better transmit and/or receive signals. When the antenna 10 and/or the antenna assembly 100 is retracted back to the body 200, the drawer structure 300 may be in the retracted state, and the wireless communication device 1000 may be stored and carried easily. When the drawer structure 300 is in the retracted state, at least a portion of the antenna 10 and/or at least a portion of the antenna assembly 100 may be located within the body 200. When the drawer structure 300 is in the extended state, at least a portion of the antenna 10 and/or at least a portion of the antenna assembly 100 may located outside the body 200. In this way, the space occupied by the wireless communication device 1000 may be reduced without affecting the normal operation of the wireless communication device 1000.

In some exemplary embodiments, the drawer structure 300 may include an antenna accommodating cavity 310, and the antenna 10 and/or the antenna assembly 100 may be accommodated within the antenna housing cavity 310. In this way, the antenna accommodating cavity 310 may provide protection to the antenna 10 and/or the antenna assembly 100, thereby prolonging the service life of the antenna 10 and/or the antenna assembly 100. In some exemplary embodiments shown in FIG. 1 and FIG. 8, the antenna substrate 12 may include a positioning hole 121 that may couple with a positioning post in the antenna housing cavity 32 to secure the antenna 10 in the antenna accommodating cavity 32. The quantity of the positioning hole 121 may be two, the corresponding quantity of the positioning post may also be two. In some exemplary embodiments, the quantity of the positioning hole 121 and the positioning post may be three, four, or any integer.

Referring to FIG. 15 and FIG. 16, in some exemplary embodiments, the wireless communication device 1000 may be a remote control, the remote control may include an antenna assembly 100 disposed inside the body 200. The antenna assembly 100 may include a first antenna group 100 and a second antenna group 130 that are spaced apart. In the first antenna group 100 and the second antenna group 130, comparing to the antenna 10, the reflector 20 may be closer to the body 200. The body 200 may be equipped with a manipulator for inputting control commands. That is, the user may hold the body 200 of the remote control and generate control commands by operating the manipulator. The manipulator may include a joystick, a button, a toggle key, and/or the like.

In some exemplary embodiments shown in the figures, the drawer structure 300 may include a telescoping rod 320 connected to the antenna accommodating cavity 310, and the sliding of the telescoping rod 320 may allow the drawer structure 300 to switch between a contracted state relative to the body 200 for easy carrying of the wireless communication device 1000, or an extended state for holding an external device 2000 (for example, a mobile phone). The quantity of the telescoping rods 320 may be two, the telescoping rod 320 may be a metal telescoping rod. The antenna accommodating cavity 310 and the telescoping rod 320 may be part of the holding external device 2000, where the relative positions of the dual antenna group, the telescoping rod 320 and the external device 2000 are designed with an orthogonal layout, that is, the telescoping rod 320 and the external device 2000 planes may be orthogonal to the antenna 10 polarization direction and may be approximately located near the structural bisecting surface of the dual antenna group. Both the telescoping rod 320 and the metal frame of the external device 2000 may sense the radiation of the dual antenna group and generate induced currents to affect the performance of the antenna 10, thus deteriorating the performance of the original antenna 10. In the present disclosure, the impact of the telescoping rod 320 and the metal frame of the mobile phone on the performance of the antenna 10 may be avoided as much as possible by the orthogonal layout design, in the following manner.

Referring to FIG. 15 and FIG. 16, the polarization direction of the dual antenna group may be parallel to the direction of the long side of the antenna substrate 12, and the telescoping rod 320 of the drawer structure 300 may be located on the structural bisecting plane of the dual antenna group orthogonal to the polarization direction of the antenna 10 (also behind the dual antenna group, with the bisecting plane shown as region X in FIG. 15). The coaxial feed line 18 of each antenna 10 may be routed from the feeding connector 16 at the center of the antenna substrate 12 along the bisecting plane through the interior of the telescoping rod 320 to connect to the interior of the body 200 of the remote control. That is, the paths of both the telescoping rod 320 and the coaxial feed line 18 may be orthogonal to the polarization direction of antenna 10. Based on the radiation characteristics of the high-frequency radiation unit 140 and the low-frequency radiation unit 141, there is almost no electric field parallel to the structural bisecting plane orthogonal to the polarization direction, that is, there is basically no electric field parallel to the current path of the telescoping rod 320, coaxial feeder 18, or the like, thus, no additional current is induced in the telescoping rod 320 and coaxial feed line 18, so the arrangement of the telescoping rod 320 and the feed route path on the surface has minimal effect on the performance of the antenna 10.

The external device 2000 may be arranged directly above a pair of telescoping rods 320. The current path formed by the metal frame of the external device 2000 and the flat metal parts contained in the PCBA circuit board, mobile phone screen inside the body 200 may also be approximately similarly laid out in a position close to the bisecting plane, which are all orthogonal to the polarization direction of the antenna 10. Such arrangement is less likely to affect the antenna 10 due to the same reason as stated above.

It should be noted that, because the reflector 20 is located directly behind the antenna 10 in the antenna assembly 100, by reflecting the backward radiation of the antenna 10 to achieve the forward directional radiation of the antenna 10, the performance of the antenna assembly 100 itself is not be susceptible to the influence of the rear structure of the antenna assembly 100.

In summary, when using the remote control, even after adding the external device 2000, the performance of the antenna assembly 100 may be substantially the same as the remote control without the external device 2000, which ensures the performance of the antenna.

In the present disclosure, the description of the reference terms “one embodiment”, “some exemplary embodiments”, “exemplary embodiments”, “example”, “specific example” or “some examples”, or the like are intended to mean that specific features, structures, materials, or characteristics described with reference to the embodiment(s) or example(s) are included in at least one embodiment or example of the present disclosure. In the present disclosure, a schematic representation of the foregoing terms does not necessarily refer to a same embodiment or a same example. In addition, the described specific features, structures, materials, or characteristics may be combined in one or more embodiments or examples in an appropriate manner.

Although the present disclosure has been illustrated and described with reference to the above exemplary embodiments, those having ordinary skills in the art should understand the technical solutions stated in the above exemplary embodiments may be changed, modified, replaced and/or varied without departing from the principles and spirits of the present disclosure. The scope of the present disclosure is defined by the claims and their equivalents thereof.

What is claimed is:

1. A remote controller for controlling an unmanned aerial vehicle (UAV), comprising:
a body; and
a drawer structure, movably connected to the body, and including an antenna; wherein
when the drawer structure moves relative to the body, the antenna moves close to or away from the body with the drawer structure.

2. The remote controller according to claim 1, wherein the drawer structure includes an antenna housing cavity to accommodate the antenna.

3. The remote controller according to claim 1, wherein drawer structure is slidably connected to the body to allow the drawer structure to be in a retracted state relative to the body or in an extended state to hold an external device.

4. The remote controller according to claim 3, wherein
at least a part of the antenna is located in the body when the drawer structure is in the retracted state; and
the antenna is located outside the body when the drawer structure is in the extended state.

5. The remote controller according to claim 1, wherein the antenna includes:
an antenna substrate; and
at least one radiation unit disposed on the antenna substrate, each of the at least one radiation unit including:
a first radiation branch, and
a second radiation branch, wherein
one of the first radiation branch or the second radiation branch is connected to a feeding point, the other of the first radiation branch or the second radiation branch is connected to a ground point, and
an end part of the first radiation branch bends toward the second radiation branch, and an end part of the second radiation branch is extend in a direction away from the first radiation branch.

6. The remote controller according to claim 5, wherein the antenna substrate includes:
a first surface; and
a second surface opposite to the first surface, wherein
the at least one radiation unit is disposed on the first surface,
a feeding connector is disposed on the second surface,
the feeding connector includes a feeding branch and a ground branch,
the feeding branch is electrically connected to the feeding point, and
the ground branch is electrically connected to the ground point.

7. The remote controller according to claim 6, wherein the feeding connector further includes:
a first connecting branch connected to the feeding branch; and
a second connecting branch connected to the ground branch, wherein
the first connecting branch and the feeding branch are connected via a first transverse connector,
an extension direction of the first connecting branch is perpendicular to an extension direction of the feeding branch,
the second connecting branch and the ground branch are connected via a second transverse connector, and
an extension direction of the second connecting branch is perpendicular to an extension direction of the ground branch.

8. The remote controller according to claim 7, wherein a connecting line between the feeding branch and the ground branch is perpendicular to a connecting line between the first connecting branch and the second connecting branch.

9. The remote controller according to claim 7, wherein
the antenna further includes a coaxial feed line,
an inner core of the coaxial feed line connected to the first connecting branch; and
a shielding layer of the coaxial feed line connected to the second connecting branch, wherein
a direction of the coaxial feed line is perpendicular to a direction of polarization of the antenna.

10. The remote controller according to claim 6, wherein
the feeding branch is connected to the feeding point via a first metal through hole formed through the antenna substrate;
the ground branch is connected to the ground point via a second metal through hole formed through the antenna substrate; and
the first metal through hole and the second metal through hole are perpendicular to the antenna substrate.

11. The remote controller according to claim 5, wherein
each of the at least one radiation unit is a high-frequency radiation unit; and
the antenna further includes:
at least one low-frequency radiation unit disposed on the antenna substrate,
each of the at least one low-frequency radiation unit including a third radiation branch and a fourth radiation branch symmetrically arranged with respect to a symmetric axis of the antenna substrate, wherein
one of the third radiation branch or the fourth radiation branch is connected to the feeding point, the other of the third radiation branch or the fourth radiation branch is connected to the ground point, and
the third radiation branch includes:
a first vertical branch,
two second vertical branches respectively connected to two opposite sides of one end of the first vertical branch via a first transverse branch, and
the first vertical branch being longer than each of the two second vertical branches.

12. The remote controller according to claim 11, wherein
the at least one radiation unit includes two high-frequency radiation units symmetrically arranged on the antenna substrate along a length direction of the first vertical branch; and
the two high-frequency radiation units are located between two ends of the low-frequency radiation unit.

13. The remote controller according to claim 5, wherein
at least one reflector is disposed on a side opposite to the at least one radiation unit;
each of the at least one reflector including a reflective substrate and a reflective branch disposed on the reflective substrate; and
the reflective branch reflects electromagnetic waves radiated by the at least one radiation unit.

14. The remote controller according to claim 13, wherein each of the at least one reflector includes two linear reflective branches.

15. The remote controller according to claim 14, wherein a geometric center of the reflective branch is located on a side, of a geometric center of the reflective substrate, deviated towards a direction of the first radiation branch.

16. The remote controller according to claim 15, wherein
the at least one radiation unit is at least one high-frequency radiation unit;
the two reflective branches are two high-frequency reflective branches to reflect high-frequency electromagnetic waves radiated by the at least one high-frequency radiation unit; and
each of the at least one antenna further includes at least one low-frequency radiation unit, wherein
the reflective substrate further includes at least one low-frequency reflective branch that reflects low-frequency electromagnetic waves radiated by the at least one low-frequency radiation unit.

17. The remote controller according to claim 16, wherein the at least one low-frequency reflective branch includes:
a third vertical branch; and
two second transverse branches, respectively connected to two opposite ends of the third vertical branch, and both extending in a direction of the two high-frequency reflective branches.

18. The remote controller according to claim 17, wherein the two high-frequency reflective branches are located within a space enclosed by the two second transverse branches and the third vertical branch.

19. The remote controller according to claim 18, wherein a low-frequency beam direction of the antenna shifts toward an opening of the at least one low-frequency reflective branch.

20. The remote controller according to claim 19, wherein
the at least one antenna includes a first antenna and a second antenna, and the at least one reflector includes a first reflector and a second reflector;
the first antenna and the first reflector form a first antenna group, and the second antenna and the second reflector form a second antenna group;
the first antenna group and the second antenna group are spaced apart; and
the opening of the first antenna group is opposite to the opening of the second antenna group.
